(19) United States
(12) Patent Application Publication
(10) Pub. No.: US 2006/0249585 A1
(43) Pub. Date: Nov. 9, 2006

(54) Non-volatile memory

(76) Inventors: Juergen Hammerschmitt, Ottobrunn (DE); Astrid Elbe, Munchen (DE); Otto Winkler, Hebertsfelden (DE)

Correspondence Address: SLATER & MATSIL LLP, 17950 PRESTON ROAD, SUITE 1000, DALLAS, TX, 75252, US

(21) Appl. No.: 11/122,759

(22) Filed: May 5, 2005

(51) Int. Cl. G06K 19/06

(52) U.S. Cl. 235/492

(57) ABSTRACT

The non-volatile memory, especially a flash-memory card, is provided with a controller circuit and a non-volatile memory, one of which comprises a counter which keeps a record of the number of write/read cycles, which is displayed to the user. This card enables the adaptation of the non-volatile memory to various applications and different requirements as to the number of specified write/read cycles.

### TECHNICAL FIELD

This invention concerns non-volatile memories and applications of non-volatile memories, especially in chip cards or non-volatile memory drives, typically in smart cards, multimedia cards, SD cards, USB drives, digital cameras and mobile phones.

### BACKGROUND

Flash-memory cards are offered for many different applications. For every application, a certain number of write and read cycles is specified, which may be, for example, a minimum of 500,000 write/erase cycles per page for the 66P UCP chip card controllers or typically 100,000 write/erase cycles for flash memories. The specified number of cycles is guaranteed by the producer. Therefore, the memory chips must be tested and selected according to their quality and expected performance. The chips that do not reach the specified standard have to be rejected.

On the other hand, some applications are provided with flash-memory cards that could be used also in applications for which a much higher number of programming cycles are specified. In other applications the total number of write/read cycles is artificially reduced, for instance the so-called disposable digital cameras (single-use cameras), which can be used only once. Except for this special application, a user of a flash-memory card is not provided with any information about the maximum number of write/read cycles that are possible or of a remaining number of write/read cycles to be performed until the card is used up. Thus, the randomness of the actual number of possible write/read cycles of flash-memory cards is in the way of an optimal exploitation of this commodity.

### SUMMARY OF THE INVENTION

In one aspect, the present invention provides a non-volatile memory that is better adapted to a special application with respect to the number of write/read cycles.

In a further aspect, the invention provides a non-volatile memory that is better adapted to the requirements of a commercial market.

In still a further aspect, the invention provides a non-volatile memory that is better suited to various applications, which require different levels of performance, especially chip cards and non-volatile memory drives.

The non-volatile memory according to the preferred embodiment of this invention makes use of a counter which counts the number of performed write/read cycles and which is arranged in or at the memory, preferably integrated in a semiconductor chip, either together with a controller circuit or in the memory. Storage capacity can preferably be provided in the memory to store a maximum number of write/read cycles as a reference, said maximum number depending on an estimated or evaluated performance of the memory. In preferred embodiments, the non-volatile memory can be a flash-memory that is programmed and erased by operating modes that are known per se.

Preferred embodiments also comprise circuitry adapted to display information about the status of the memory, e.g., either by displaying the number of write/read cycles already performed or by displaying a remaining number of write/read cycles according to a specified total number of cycles. To this purpose, a display can be integrated together with the memory on the same carrier, for instance on a chip card. The displays of devices such as mobile phones can also be used, if their standard function is enhanced accordingly. Also, displays of terminals or external devices such as chip card readers can be used to show the status of the memory.

Additional means may be provided to block a function of the memory after a specified number of write/read cycles. The number of cycles can be specified in advance according to the relevant commercial requirements, for instance depending on the price of the memory. The blocking mechanism is preferably realized by additional electronic circuits, which may be integrated in a controller circuitry of the memory.

Further means may be provided to restore a blocked function and to enable a further number of write/read cycles, for example after a payment of a fee for the further use of the memory. In this manner, the application of the memory can be adapted to the special requirements of the user. The memory can also be provided with a plurality of different levels of performance, which can be activated and adjusted to the customer's wishes. The additional operations may also be implemented, for example, in the controller circuitry. The inventive feature of the integrated counter offers a multitude of new applications.

It is of advantage for the customer, if he can buy flash-memory cards of different price levels depending on the number of write/read cycles which can be performed in the respective application. The revenues of the producers are increased, because the produced cards can be used according to their individual quality level, and the number of rejects are thus reduced. Programmable flash-memory cards can be offered with an explicit specification of a different number of write/read cycles according to the application. This is especially advantageous in the case of flash-memory cards like MMC, SD cards and USB drives.

The non-volatile memories according to the preferred embodiment of this invention can be provided by memory chips that have been selected or classified by cycling and data retention tests that are performed in the course of a standard production process. A storage of the expected maximum number of write/read cycles of the flash-memory chips that belong to a selection in the non-volatile memory may render a variety of memories of different specified quality or different specified levels of performance. The customer can choose according to his own requirements and demands and need not pay more than necessary for the memory which he chooses for his application.

The non-volatile memory according to embodiments of this invention can be used in conjunction with devices that are already integrated in controller circuits of memory chips and detect memory cells that are no longer usable or that are prone to degradation. Circuitry, such as a disturb counter, can be used to keep a record of the number of cycles already performed or of the remaining number of possible write/read cycles that can be displayed either on a display that is combined with the memory or on a display of a terminal or some other external device belonging to the application of the memory, for example an application in a flash-memory card. In this manner, the user is always informed of the state of his non-volatile memory and is able to check how long or how often the memory will be applicable.

Circuitry can be provided to restore or reactivate a memory which is initially provided with a number of write/read cycles that is smaller than the maximum possible number of cycles. After the payment of the corresponding fee, the memory is switched into an operating mode which provides a further specified number of write/read cycles, until the memory is definitely and finally used up.

If testing circuitry or an electronic circuit is provided to check the degradation of the memory cells or to estimate or evaluate the residual lifetime of the memory by the number of memory cells that have already been cancelled from a table of addresses, because they do no longer operate, a continuous update of the remaining number of write/read cycles is also possible. If the user is warned of a premature failure of the memory device by means of a suitable display, they can exchange the memory in time for a new copy. If the memory is provided with a blocking function, applications such as mobile phone or internet offer the possibility to activate the memory online on the customer's request. Thus the non-volatile memory according to the invention offers a plurality of new applications and an improved usage of new media, and enables an adaptation of the specified number of write/read cycles to a mercantile agreement.

These and other features and advantages of the invention will become apparent from the following brief description of the drawings, detailed description and appended claims and drawings.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a schematic plan view of a first embodiment of an examplary flash-memory card;

FIG. 2 shows a schematic plan view according to FIG. 1 of a second embodiment of an exemplary flash-memory card;

FIG. 3 illustrates an application of the non-volatile memory with counter in a chip card using the display of a chip card reader;

FIG. 4 illustrates an application of the non-volatile memory with counter in a chip card using an integrated display; and

FIG. 5 shows a diagram of components used in exemplary applications of the non-volatile memory with counter.

The following list of reference symbols can be used in conjunction with the figures.
1 card body
2 contact
3 controller circuit
4 non-volatile memory
5 counter
6 display
7 chip card reader
8 chip card
9 chip
10 additional non-volatile memory

### DETAILED DESCRIPTION OF ILLUSTRATIVE EMBODIMENTS

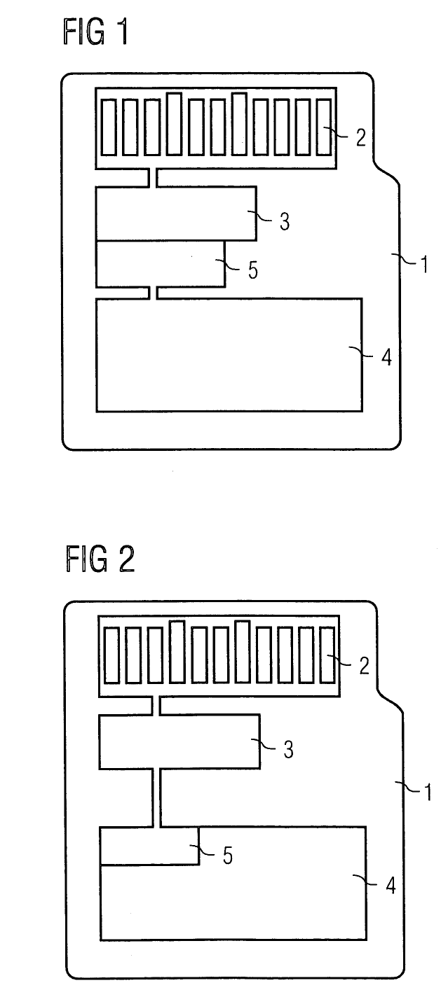

FIG. 1 shows a card body 1 of an embodiment of an exemplary flash-memory card comprising a non-volatile memory according to this invention. A peripheral region of the card body 1 can be supplied with contacts 2 that serve as an electric connection of the circuitry that is integrated on or in the card body 1. But the inventive non-volatile memory also comprises embodiments that work without electric contacts. A controller circuit 3 is provided as an addressing periphery to the non-volatile memory 4. In this first embodiment, the integrated counter 5 forms a part of the controller circuit 3. Although, for the sake of clarity, the counter 5 is drawn slightly detached from the region of the controller circuit 3, the counter 5 can be fully integrated into the controller circuit chip 3. The controller circuit 3 can also comprise a blocking function that is provided to block the memory after a specified number of write/read cycles. The blocking function can be designed so that it can be

FIG. 2 shows the plan view according to FIG. 1 for a further embodiment, in which the counter 5 is integrated as part of the non-volatile memory 4. In both embodiments, a display of the number of write/read cycles can also be integrated on the card body 1. Instead, the counter 5 can be read and the stored information displayed on some external equipment, which can be connected via the electric contacts. Although the card body 1 shown in the figures has a similar shape in both embodiments, it should be understood that the card body can have any shape which is suitable for the relevant application of the flash-memory card. The format of the card that is represented in the figures is only one example.

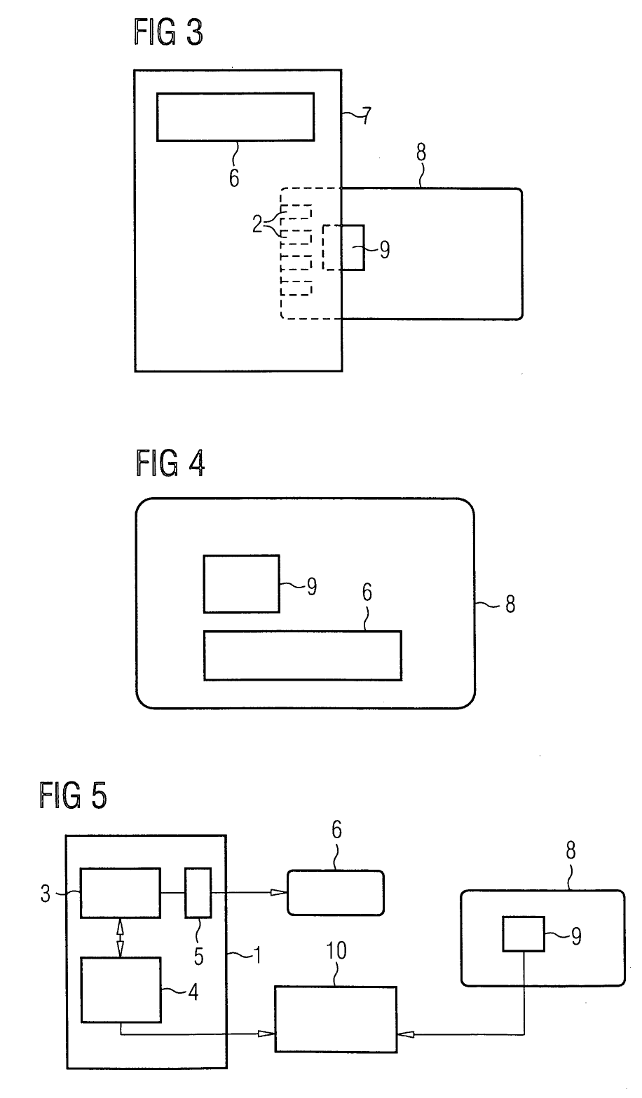

FIG. 3 shows an arrangement of a chip card 8 using the display 6 of a chip card reader 7, which is an example of an application of the non-volatile memory with counter. The location of the chip 9 and the contacts 2 is indicated merely as an illustrative example and may differ in various embodiments. The display 6 can be a standard device that is appropriate to read out information that is stored in the chip 9. Such a display is additionally used here to display the present status of the memory that is integrated in the chip card and is provided with a counter to keep a record of the write/read cycles already performed.

FIG. 4 shows an alternative embodiment of the integration of the memory with counter in a chip card 8, which in this embodiment comprises a display 6 of its own. The display may be a standard device that is provided to read out the information stored in the memory of the chip 9; or the display may be integrated for the sole purpose of displaying the number of already performed or still remaining write/read cycles.

FIG. 5 shows a diagram of the interaction of components that are used in exemplary applications of the non-volatile memory with counter. A typical application of the inventive non-volatile memory in a chip card or flash card comprises the following steps: The read counter 5 integrated in a card body 1 is set to a maximal value that is specified in advance, for instance 500,000 cycles. During production tests, a so-called bad block management circuitry of the controller circuit 3 is used. Bits of information of the bad block management or disturb counter are read out by the read counter, which counts down the number of programming cycles feasible with the integrated non-volatile memory 4 according to the outcome of the test. After the product test, the cards can be sorted out according to the number of read cycles stated by the read counter. During the operation of the card in a mobile phone, digital camera or similar device, the number of possible write/read cycles is calculated in the same way as during the production tests. Thus, the user can be informed about the residual lifetime of the card on the display 6, which in this example is taken to be provided separately. The remaining lifetime can be calculated, for example, by dividing the counted number of read cycles by the number of read cycles that are typically specified for a relevant application, for instance saving photographs. When the lifetime of the card has dropped below a critical value, the user may wish to store the memory contents on a further, additional memory 10. A similar procedure is advantageous with chip cards 8 that are provided with a chip 9 comprising a non-volatile memory with counter.

Although the present invention and its advantages have been described in detail, it should be understood that various changes, substitutions and alterations can be made herein without departing from the spirit and scope of the invention as defined by the appended claims.

What is claimed is:

1. A non-volatile memory, comprising:
a non-volatile memory chip; and
a counter that is either coupled to the non-volatile memory chip or integrated with the non-volatile memory chip, said counter being provided to keep a record of a number of write/read cycles.

2. The non-volatile memory as claimed in claim 1, further comprising a display coupled to said counter, said display being provided to display one of a performed number of write/read cycles or a remaining number of write/read cycles according to a specified total of write/read cycles.

3. The non-volatile memory as claimed in claim 1, further comprising a circuit configured to block a function or application of the memory after a number of write/read cycles specified in advance.

4. The non-volatile memory as claimed in claim 3, wherein said circuit is further configured to restore a blocked function or application for a further number of write/read cycles according to a specification.

5. The non-volatile memory as claimed in claim 4, wherein said circuit is further configured to enable an adaptation of said specified number of write/read cycles to a mercantile agreement.

6. The non-volatile memory as claimed in claim 1, further comprising a control circuit provided to check a state of degradation of the memory and to adjust a record of remaining of write/read cycles accordingly.

7. The non-volatile memory as claimed in claim 1, wherein the non-volatile memory unit includes a storage location that is provided to store a maximum number of write/read cycles as a reference, said maximum number depending on an estimated or evaluated performance of the memory.

8. A chip card, comprising:
a card body;
a controller circuit on said card body;
a non-volatile memory on said card body, said non-volatile memory being addressed by said controller circuit; and
a counter, said counter being integrated with one of said controller circuit or said non-volatile memory and being provided to keep a record of a number of write/read cycles performed with said non-volatile memory.

9. The chip card as claimed in claim 8, further comprising a display coupled to the counter, the display to display information regarding the number of write/read cycles.

10. The chip card as claimed in claim 9, wherein the information regarding the number of write/read cycles comprises a number of write/read cycles already performed.

11. The chip card as claimed in claim 9, wherein the information regarding the number of write/read cycles comprises a remaining number of write/read cycles according to a specified total of write/read cycles.

12. The chip card as claimed in claim 8, wherein said card is provided for an application selected from the group consisting of smart card, multimedia card, SD card, USB drive, digital camera, and mobile phone.

13. The chip card as claimed in claim 8, further comprising a mechanism to block a function or application of the card after the number of write/read cycles performed with said non-volatile memory exceeds a limit.

14. The chip card as claimed in claim 13, further comprising a mechanism to restore the blocked function or application for a further number of write/read cycles.

15. The chip card as claimed in claim 14, wherein the mechanism to restore is provided to enable a specified number of write/read cycles according to a mercantile agreement.

16. The chip card as claimed in claim 8, further comprising a mechanism to control a state of degradation of said non-volatile memory and to adjust the record of a remaining number of write/read cycles accordingly.

17. The chip card as claimed in claim 8, further comprising a storage unit that stores a maximum number of write/read cycles as a reference, said maximum number depending on an estimated or evaluated performance of the memory.

18. A method of operating a non-volatile memory, the method comprising:
performing a data access operation on a non-volatile memory device;
incrementing a counter to keep track of a number of data access operations, the counter being attached to the non-volatile memory device; and
performing an operation based upon the number of data access operations that are being kept track of in the counter.

19. The method of claim 18, wherein performing an operation comprises displaying information related to the number of data access operations.

20. The method of claim 19, wherein the information regarding the number of data access operations comprises the number of data access operations already performed.

21. The method of claim 19, wherein the information regarding the number of data access operations comprises a remaining number of data access operations according to a specified total of write/read cycles.

22. The method of claim 18, wherein the counter and the non-volatile memory are integrated into a single integrated circuit chip.

23. The method of claim 18, further comprising blocking a function or application of the non-volatile memory after the number of data access operations performed within said non-volatile memory exceeds a limit.

24. The method of claim 23, further comprising restoring the blocked function or application for an additional number of data access operations.

25. The method of claim 24, wherein the additional number of data access operations is specified by a mercantile agreement.

26. The method of claim 18, further comprising controlling a state of degradation of said non-volatile memory and adjusting the record of a remaining number of write/read cycles accordingly.

27. The method of claim 18, further comprising storing a maximum number of data access operations as a reference, said maximum number depending on an estimated or evaluated performance of the non-volatile memory.
